(19) United States
(12) Patent Application Publication
(10) Pub. No.: US 2025/0023188 A1
(43) Pub. Date: Jan. 16, 2025

(54) FORMED IN PLACE VENT CHANNEL

(71) Applicant: Our Next Energy, Inc., Novi, MI (US)

(72) Inventor: Nathan Saliga, Clarkston, MI (US)

(21) Appl. No.: 18/772,073

(22) Filed: Jul. 12, 2024

Related U.S. Application Data
(60) Provisional application No. 63/526,511, filed on Jul. 13, 2023.

(51) Int. Cl. H01M 50/375; H01M 50/293; H01M 50/367; H01M 50/383

(52) U.S. Cl. CPC H01M 50/375; H01M 50/293; H01M 50/367; H01M 50/383

(57) ABSTRACT

A battery pack that includes a battery pack housing, and an encapsulating foam material that encapsulates a number of cells. Each cell has a cell vent arranged on a first side of the cell. The battery pack also includes a vent channel that includes a reception duct that includes adjacent sections, and a connection duct. The vent channel is positioned in place, by the encapsulating foam material, such that the reception duct is opposite the cell vents and such that each cell vent corresponds to and faces an adjacent section. The melting point of the material of the adjacent sections is below a predetermined cell venting temperature, and each adjacent section can melt upon contact with escaping gas from the corresponding cell vent to direct the escaping gas to an external area of the battery pack through the connection duct.

### BACKGROUND

### Technical Field

The present disclosure generally relates to cell vents and more particularly to a battery pack with a venting system that is formed in place in the battery pack.

### Description of the Related Art

Battery cells have been used in a wide array of applications including electric vehicles and energy storage systems to provide a source of energy. The battery cells charge and discharge by moving metal ions between a positive electrode and a negative electrode. A battery may experience safety issues such as a short circuit and the battery may undergo internal temperature and pressure changes that may lead to problems without proper management. Considering these, proper design of venting systems is crucial to optimal battery performance.

### BRIEF SUMMARY

According to an embodiment of the present disclosure, a battery pack is disclosed. The battery pack includes a battery pack housing, and an encapsulating foam material that encapsulates a number of cells. Each cell has a cell vent arranged on a first side of the cell. The battery pack also includes a vent channel that further includes a reception duct with adjacent sections, and a connection duct. The vent channel is positioned in place, by the encapsulating foam material, such that the reception duct is opposite the cell vents and such that each cell vent corresponds to and faces an adjacent section. The melting point of the material of the adjacent sections is below a predetermined cell venting temperature, and each adjacent section can melt upon contact with escaping gas from the corresponding cell vent to direct the escaping gas to an external area of the battery pack through the connection duct.

In an embodiment, the vent channel is a thermoplastic vacuum formed thin-walled vent channel.

In an embodiment, a method of manufacturing a battery pack is disclosed. The method includes providing a battery pack housing, providing a first material that expand into an encapsulating foam material, providing a number of cells each cell including a corresponding cell vents, arranging the cells in the battery pack housing, providing a vent channel includes, and positioning the vent channel in place in the battery pack by introducing a first material to the battery pack, and hardening the first material to generate the encapsulating foam material, such that the first reception channel is positioned opposite the first plurality of corresponding cell vents and such that each corresponding cell vent corresponds to and faces an adjacent section of the plurality of adjacent sections. A melting point of the material of the plurality of adjacent sections is selected to be below a predetermined cell venting temperature, and upon contact with the escaping gas, each adjacent section melts to direct the escaping gas to an external area of the battery pack through a connection duct of the vent channel.

### BRIEF DESCRIPTION OF THE DRAWINGS

To easily identify the discussion of any particular element or act, the most significant digit or digits in a reference number refer to the figure number in which that element is first introduced.

FIG. 1 depicts an exploded view of a battery pack showing a hardened encapsulating foam material in accordance with an illustrative embodiment.

FIG. 2 depicts a perspective view of a cell in accordance with an illustrative embodiment.

FIG. 3 depicts a front view of a plurality of cells and a reception duct of a vent channel in accordance with an illustrative embodiment.

FIG. 4 depicts a perspective view of a plurality of rows of cells and a vent channel in accordance with an illustrative embodiment.

FIG. 5 depicts a perspective view of a plurality of rows of cells, a vent channel and a battery pack housing in accordance with an illustrative embodiment.

FIG. 6 depicts a perspective view of a plurality of rows of cells, a vent channel and a battery pack housing in accordance with an illustrative embodiment.

FIG. 7 depicts a perspective view of a battery pack in accordance with an illustrative embodiment.

FIG. 8A depicts an exploded view of a battery pack showing a hardened encapsulating foam material in accordance with an illustrative embodiment.

FIG. 8B depicts a cross section of a battery pack in accordance with an illustrative embodiment.

FIG. 9 depicts a two-dimensional (2D) view of an end of a battery pack in accordance with an illustrative embodiment.

FIG. 10 depicts a perspective view of a battery pack in accordance with an illustrative embodiment.

FIG. 11 depicts a process in accordance with an illustrative embodiment.

FIG. 12 depicts a functional block diagram of a computer hardware platform in accordance with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below”, or “beneath” other elements or features would then be oriented “above” the other elements or features. Thus, for example, the term “below” can encompass both an orientation that is above, as well as below. The device may be otherwise oriented (rotated 90 degrees or viewed or referenced at other orientations) and the spatially relative descriptors used herein should be interpreted accordingly.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells and their fabrication may or may not be described in detail herein. Moreover, the various tasks and process steps described herein can be incorporated into a more comprehensive procedure or process having additional steps or functionality not described in detail herein.

Turning now to an overview of technologies that generally relate to the present teachings, venting systems are an essential safety component of battery packs to reduce the dangers of battery failures and thermal events. Battery packs in electric cars often comprise various separate cells connected in series or in parallel. Battery cells may produce heat in normal operation as a result of internal chemical processes. Active cooling systems, including liquid cooling or air cooling, which help maintain ideal operating temperatures, may be used to manage the heat. The cells, however, may overheat or exhibit thermal runaway—a rapid and uncontrollable increase in temperature—under specific conditions, such as overcharging, high ambient temperatures, or mechanical damage. The use of venting systems in battery packs may stop catastrophic failures. However, in a design in which a battery pack is filled with solid material, vent gases may have difficulty escaping from the cells due to, for example, obstruction by the solid material and may cause also cause further damage due to their high temperature and pressure.

The illustrative embodiments disclose a battery pack comprising dedicated duct channels configured to transport vent gases to a pack vent. The battery pack may comprise low melting point tubes disposed adjacent to the cell vents and leading to the pack vent. In an embodiment, the tubes may comprise foam tubes that may evaporate during a pack venting event. In another embodiment, the tubes may have a material with a melting point below that of the escaping gas. This may allow manufacturing to include the tubes during assembly and place expanding interior foam material around them. Upon venting, the escaping gas may would pierce through the expanding foam by melting/evaporating portions of the foam in place tubes for the escaping gas to reach a pack vent.

The illustrative embodiments further disclose a method of manufacturing a battery pack comprising the foam in place tubes without significant mechanical integration.

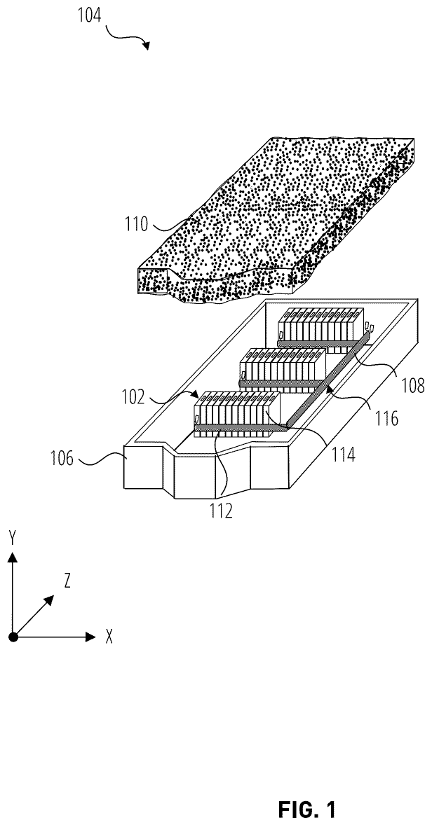

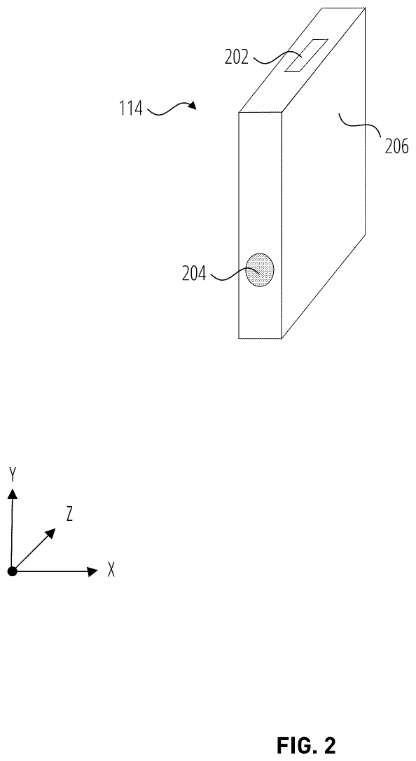

FIG. 1 illustrates a battery pack 104 showing an encapsulating foam material 110 and other components of the battery pack in accordance with an illustrative embodiment. The battery pack 104 comprises a battery pack housing 106, the encapsulating foam material 110, and a plurality of cells 102 comprising a first plurality of corresponding cell vents, the plurality of cells being arranged in the battery pack housing and each cell 114 of the plurality of cells including a cell vent 204 arranged on a first side of the cell. As shown in FIG. 2, which illustrates a perspective view of a cell 114 in accordance with an illustrative embodiment, the first side can be any side such as any side perpendicular to the side containing the cap assembly or terminal 202, or any side parallel to the side containing the cap assembly or terminal. The cell 114 of FIG. 2 may comprise a large wall surface 206 that is parallel to the YZ plane, the YZ plane being a two-dimensional plane in three-dimensional space that is perpendicular to the X-axis and that is perpendicular to a surface of the cell which has the terminal 202 or cap assembly.

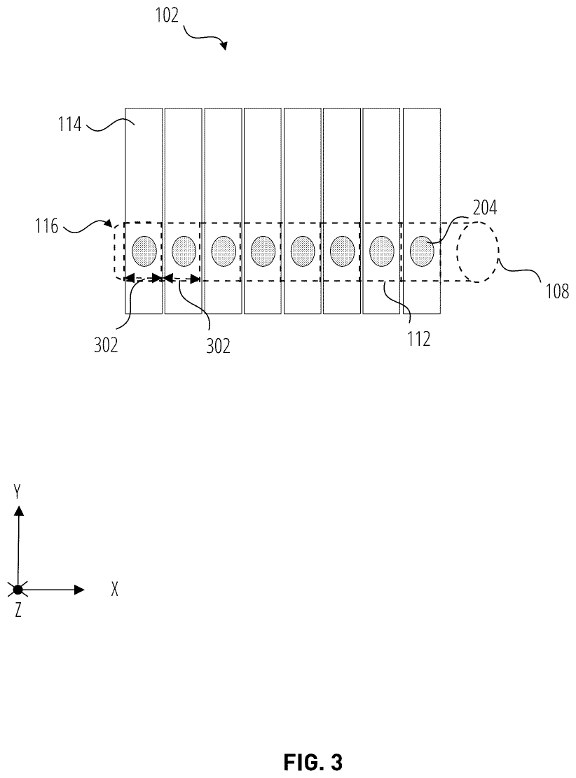

Turning back to FIG. 1, the battery pack 104 further comprises a vent channel 116 which comprises a reception duct 112 and connection duct 108. The vent channel 116 may be, in an aspect herein, a thermoplastic vacuum formed thin-walled vent channel wherein a wall thickness thereof may be configured with enough structure such that it is self-supporting and can survive the manufacturing process and foam expansion forces. The wall thickness may be, for example, 0.5-2 mm thick. The vent channel 116 may be positioned in place, by the encapsulating foam material 110, such that the reception duct 112 is disposed opposite the cell vents 204 and such that each cell vent corresponds to and faces an adjacent section 302 of reception duct 112 as shown in FIG. 3. More specifically, FIG. 3 illustrates a front view of a plurality of cells 102 adjacent to each other and arranged in a row, and a reception duct 112 of a vent channel 116 lined up with the plurality of cells 102 in the X and Y directions for illustration. The vent channel is shown in dashed lines for illustration purposes. The reception duct 112 may comprise a plurality of adjacent sections 302, each adjacent section 302 further comprising a whole portion or a sub-portion thereof that is configured to be melted or blown away by escaping gas escaping from the cell vent 204. The sub-portion may be, for example, a similar shape as the shape of the cell vent 204. The sub-portion may also be at least a same size or larger than the size of the corresponding cell vent.

Further, the melting point of a material of the plurality of adjacent sections 302 may be below a predetermined temperature of the escaping gas such that each adjacent section may melt upon contact with escaping gas from the corresponding cell vent to direct the escaping gas to an external area of the battery pack through the connection duct 108.

In an aspect herein, the adjacent section 302 may be a section of the reception duct closest to the cell vent 204 whereas another section of the reception duct further away (in the Z-direction) from the cell vent 204 may have a melting point above the predetermined cell venting temperature. Therefore, the walls of the reception duct 112 may be able to direct the escaping gas to the connection duct and to an external area of the pack. Thus, the melting point of the material of the adjacent sections 302 may be below the melting point of the material of the remainder of the vent channel 116 as well as below the predetermined cell venting temperature.

In another aspect herein, the melting point of the encapsulating foam material 110 may be below the predetermined cell venting temperature such that the encapsulating foam material between a cell vent 204 and a corresponding adjacent section placed opposite the cell vent may be melted by the escaping gas prior to melting the adjacent section. The encapsulating foam material may be a flame retardant or flame resistant and may be rated UL 94V-0. The cell vent may also comprise membrane material different from a material of the rest of the housing of the cell.

In an exemplary embodiment, the cell vent temperatures may be between 400-500° C. The encapsulating foam material 110 and the adjacent section 302 of the vent channel may be tuned to have a lower melting point than the predetermined cell venting temperature by performing material selection based on the gas temperature to ensure that the foam and adjacent sections can be melted in an abuse situation (such as short circuits) while having a structurally sound material during normal operation. Furthermore, the encapsulating foam material 110 or at least a portion thereof may be configured to be blown away by pressure of the escaping gas by using a high strength low density foam. The density of the encapsulating foam material may be selected to be between 3-8 lbs/ft³ and a compressive yield strength of the encapsulating foam material may be between 15-30 MPa.

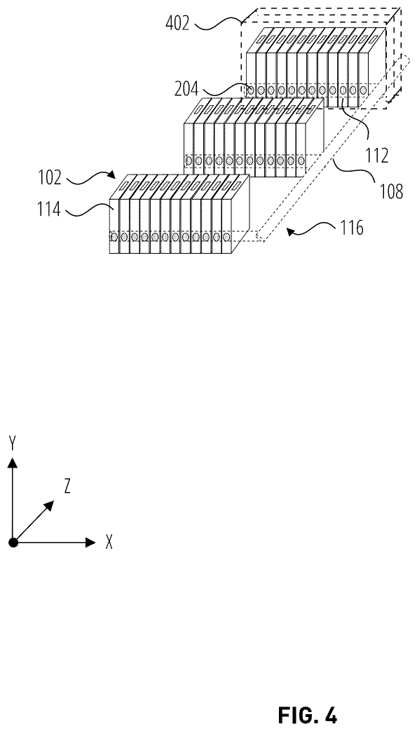

Turning now to FIG. 4, a perspective view of a plurality of rows of cells and a vent channel is shown to illustrate a module 402. A collection of cells 114 may be disposed in the module 402 and the reception duct 112 may be disposed inside or outside the module 402 in a position that is aligned with the cell vents 204. In the case where the reception duct 112 is disposed inside the module, the adjacent sections 302 of the reception duct 112 may be aligned with corresponding cell vents and the adjacent sections 302 may be melted in a thermal event to eject escaping gas to an external area of the battery pack through the connection duct. In the case where the reception duct 112 is disposed outside the module 402, the adjacent section 302 of the reception duct 112 may still be aligned with the corresponding cell vent 204. However, portions of the module in between the reception duct 112 and the cell vent 204 may be adapted with module vents (not shown) that may be melted or blown away by escaping vent gas prior to the escaping vent gas reaching the adjacent sections external to the module.

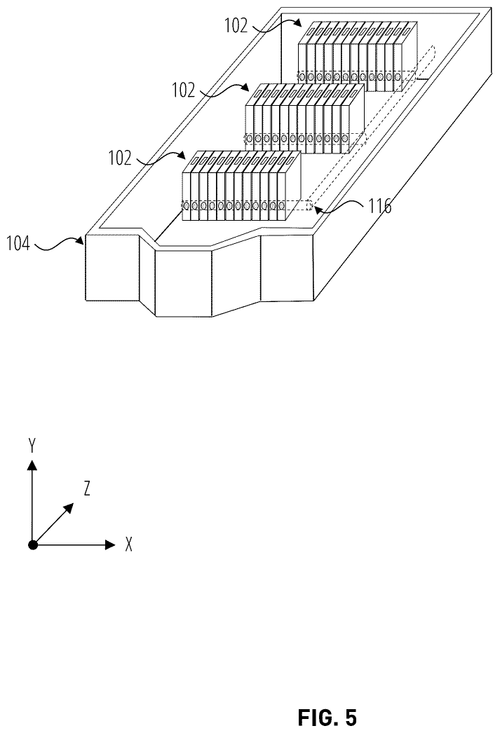

FIG. 5 illustrates a perspective view of a battery pack prior to introducing the encapsulating foam material. In the figure, three rows of a plurality of cells 102 are depicted for illustration purposes. The battery pack 104 may thus further comprise at least one other plurality of cells and one at least one other reception duct corresponding to the at least one other plurality of cells, the at least one other reception duct being configured with another plurality of adjacent sections to direct the escaping gas from the at least one other plurality of cells to an external area of the battery pack through the common connection duct. Of course, this is not meant to be limiting as any number of cells, modules, and reception ducts or even other vent channels may be obtained in view of the descriptions herein.

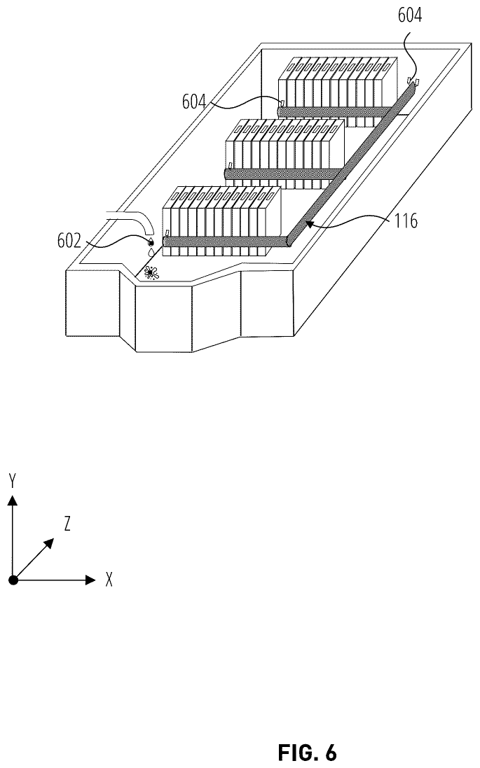

FIG. 6 illustrates a perspective view of a battery pack with the vent channel being loosely held in place by fixtures 604 or clippings prior to introductions of the encapsulating foam material. The encapsulating foam material may be initially introduced as, for example, a liquid expanding foam 602 which may subsequently harden into the encapsulating foam material 110, which may hold the vent channel 116 in place. The fixtures 604 may optionally be removed after hardening of the liquid expanding foam 602. Of course, other materials that may initially conform to the shape of the vent channel 116 and subsequently change states to hold the vent channel 116 in place may be used.

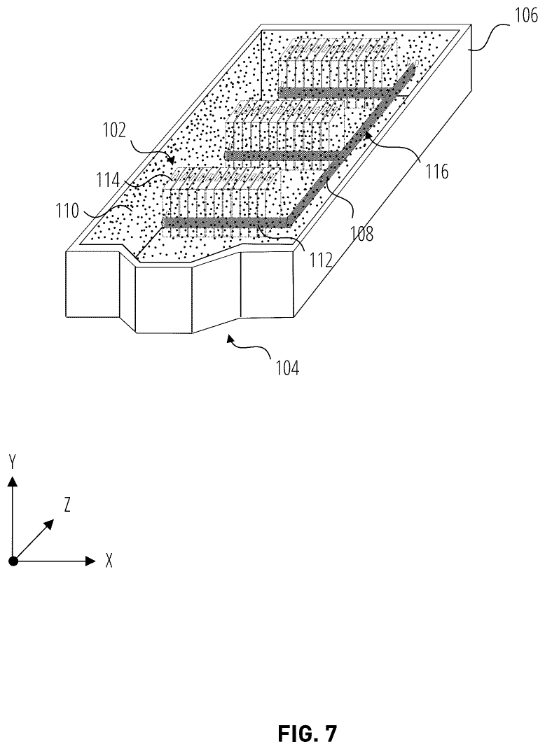

FIG. 7 illustrates a perspective view of the battery pack after solidification of the encapsulating foam material 110. Components of the battery pack such as the plurality of cells 102, connection duct 108, and reception duct 112, are shown as being covered by the encapsulating foam material for illustration.

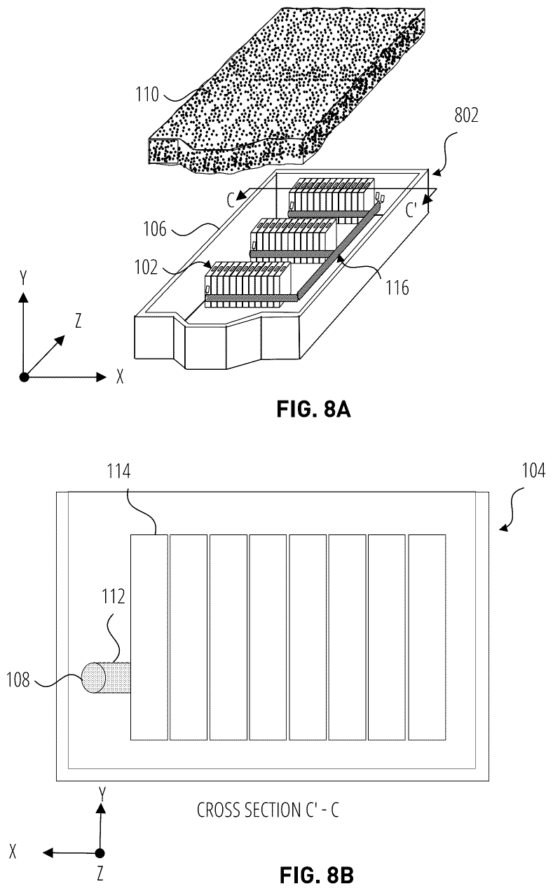

FIG. 8A is an exploded view of a battery pack showing a line CC′ in the X-direction. A cross-section is taken in the XY plane along the line CC′. FIG. 8B shows the resulting cross sectional view C′-C illustrating the relative positions of the connection duct 108, the reception duct 112 and the cells 114.

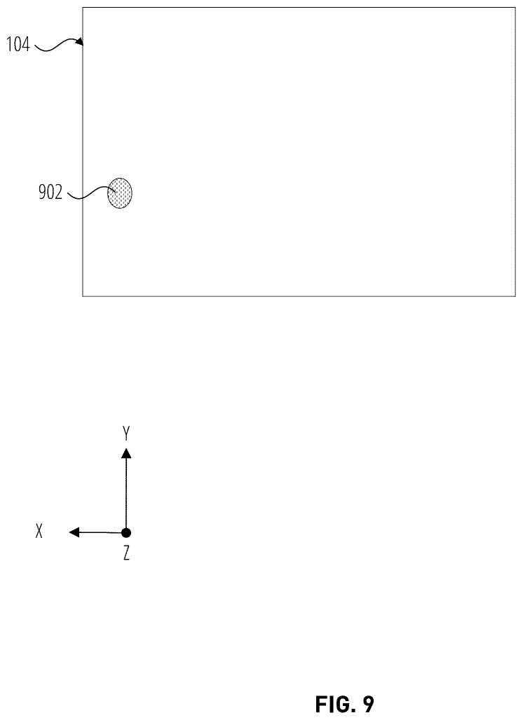

FIG. 9 depicts a two-dimensional (2D) view of an end of a battery pack viewed from the back direction 802 of FIG. 8A. In accordance with an illustrative embodiment, the battery pack housing 106 may comprise a pack vent 902 adapted to be melted or blown away by the escaping gas through the connection duct 108. The pack vent 902 may have a melting point below the predetermined cell venting temperature. The pack vent 902 may also have a melting point below the melting point of the remainder of the material of the battery pack housing 106. Alternatively, the pack vent 902 may be a hole through which the escaping gas may pass.

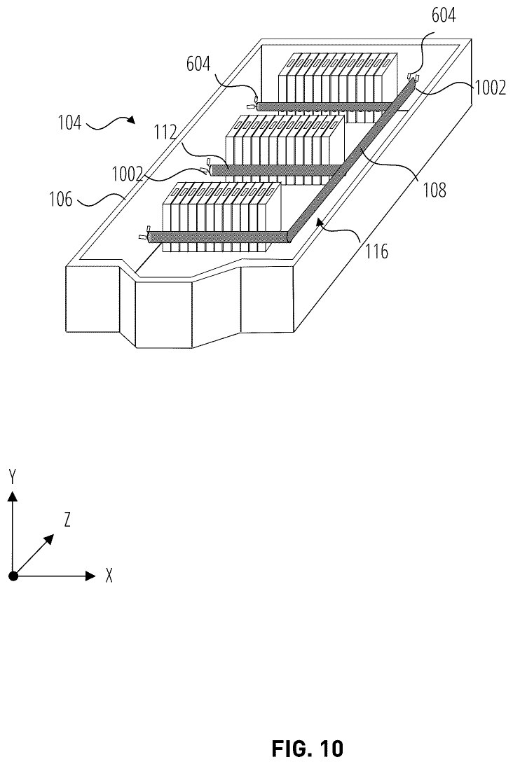

Turning now to FIG. 10, an embodiment is shown wherein the vent channel 116 has an open end 1002 for not just the connection duct 108 to transport escaping gas out of the battery pack but also for the reception ducts 112 to transport escaping gas out of the battery pack. The open ends 1002 may directly face walls of the battery pack housing 106 which may be weakened at an interface thereof or adapted with pack vents 902 to be melted or blown away by the escaping gas.

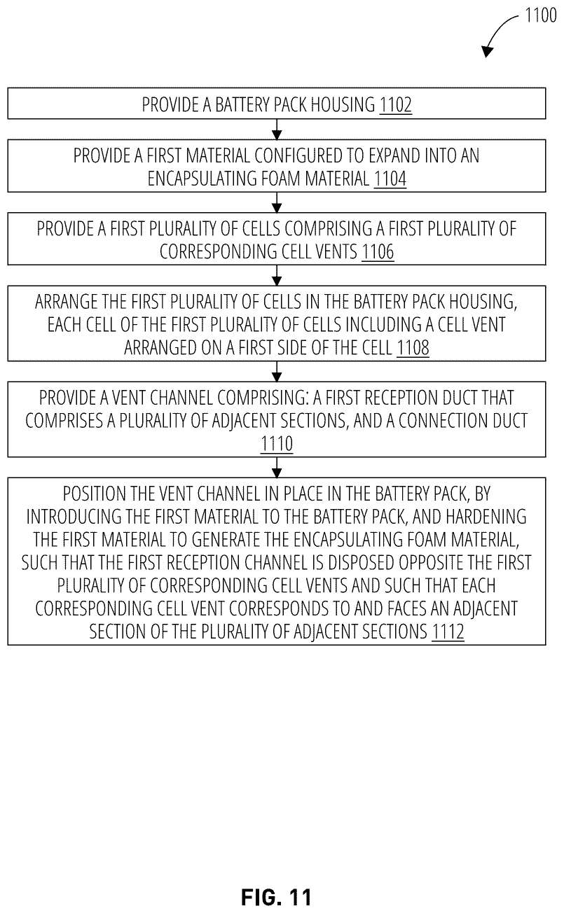

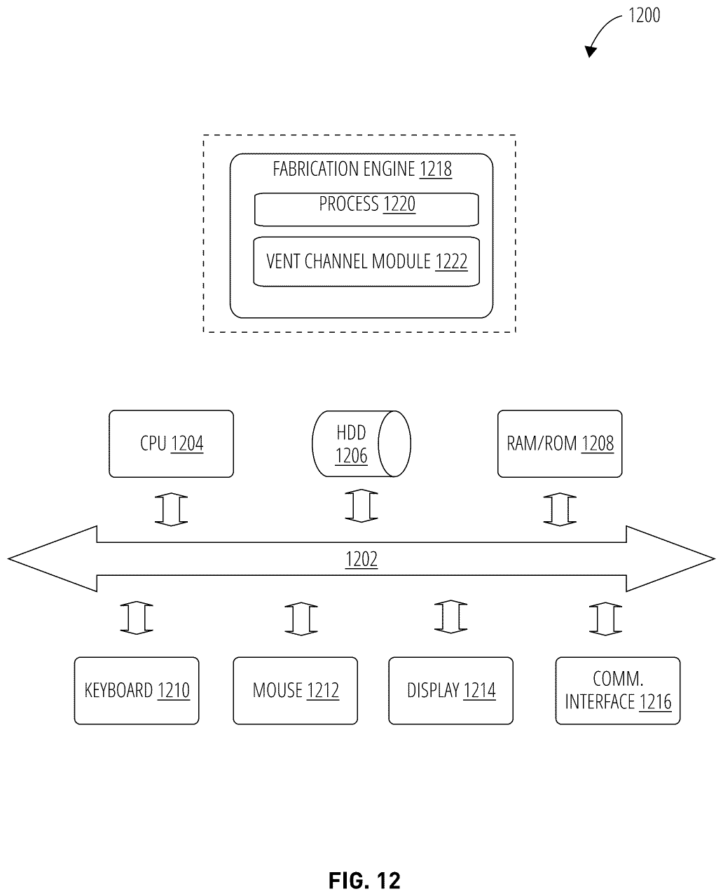

Turning now to FIG. 11, a process 1100 for manufacturing the battery pack 104 is described. The routing may be performed or controlled, for example, by the fabrication engine 1218 of FIG. 12. In block 1102, the fabrication engine 1218 may provide a battery pack housing. In block 1104, the fabrication engine 1218 may provide a first material configured to expand into an encapsulating foam material. The first material may be, for example, a liquid expanding foam. In block 1106, fabrication engine 1218 may provide a first plurality of cells comprising a first plurality of corresponding cell vents. In block 1108, fabrication engine 1218 may arrange the first plurality of cells in the battery pack housing, each cell of the first plurality of cells including a cell vent arranged on a first side of the cell. In block 1110, fabrication engine 1218 may provide a vent channel comprising: a first reception duct that comprises a plurality of adjacent sections, and a connection duct. In block 1112, fabrication engine 1218 may position the vent channel in place in the battery pack, by introducing the first material to the battery pack, and hardening the first material or allowing the first material to harden and expand to generate the encapsulating foam material, such that the first reception channel is disposed opposite the first plurality of corresponding cell vents and such that each corresponding cell vent corresponds to and faces an adjacent section of the plurality of adjacent sections. The vent channel may be positioned in place initially with one or more fixture or clipping prior to introducing the first material. The fabrication engine 1218 may configure the melting point of the material of the plurality of adjacent sections to be below a predetermined cell venting temperature such that adjacent section melts upon contact with escaping gas from the corresponding cell vent to direct the escaping gas to an external area of the battery pack through the connection duct.

As discussed above, functions relating to methods and systems for fabricating a battery pack with a formed in place vent channel can use of one or more mechanical and computing devices connected for data communication via wireless or wired communication. FIG. 12 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 1200 may include a central processing unit (CPU) 1204, a hard disk drive (HDD) 1206, random access memory (RAM) and/or read only memory (ROM) 1208, a keyboard 1210, a mouse 1212, a display 1214, and a communication interface 1216, which are connected to a system bus 1202.

In one embodiment, the hard disk drive (HDD) 1206, has capabilities that include storing a program that can execute various processes, such as the fabrication engine 1218, in a manner described herein. The fabrication engine 1218 may have various modules configured to perform different functions. For example, a process module 1220 may be configured to control the different manufacturing processes discussed herein and others. A vent channel module 1222 may be operable to provide an appropriate positioning, dimensioning, formation in place, timing of a solidification process of the first material and in general, manufacturing of a battery pack with a formed in place vent channel.

For the sake of brevity, conventional techniques related to making and using aspects of the disclosure may or may not be described in detail herein. In particular, various aspects of manufacturing and computing systems and specific programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or system. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted, or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” and similar terms can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A battery pack comprising:
a battery pack housing;
an encapsulating foam material;
a first plurality of cells comprising a first plurality of corresponding cell vents, the first plurality of cells being arranged in the battery pack housing and each cell of the first plurality of cells including a cell vent of the first plurality of corresponding cell vents arranged on a first side of the cell; and
a vent channel comprising:
a first reception duct that comprises a plurality of adjacent sections; and
a connection duct,
the vent channel positioned in place, by the encapsulating foam material, such that the first reception duct is disposed opposite the first plurality of corresponding cell vents and such that each corresponding cell vent corresponds to and faces an adjacent section of the plurality of adjacent sections;
wherein a melting point of a material of the plurality of adjacent sections is below a predetermined cell venting temperature, and
wherein each adjacent section is configured to melt upon contact with escaping gas from the corresponding cell vent to direct the escaping gas to an external area of the battery pack through the connection duct.

2. The battery pack of claim 1, wherein the melting point of the material of the plurality of adjacent sections is below the melting point of the material of a remainder of the vent channel.

3. The battery pack of claim 1, wherein the melting point of the encapsulating foam material is below the predetermined cell venting temperature.

4. The battery pack of claim 1, wherein the first plurality of cells are arranged in a module disposed in the battery pack.

5. The battery pack of claim 1, wherein the battery pack housing comprises a pack vent configured to be displaced or melted by the escaping gas.

6. The battery pack of claim 1, wherein the first plurality of cells are arranged in a row.

7. The battery pack of claim 1, further comprising:
at least one other plurality of cells and one at least one other reception duct corresponding to the at least one other plurality of cells, the at least one other reception duct being configured with another plurality of adjacent sections to direct escaping gas from the at least one other plurality of cells to the external area of the battery pack through the connection duct.

8. The battery pack of claim 1, wherein the vent channel is a thermoplastic vacuum formed thin-walled vent channel.

9. The battery pack of claim 1, wherein the encapsulating foam material is flame retardant.

10. The battery pack of claim 9, wherein the encapsulating foam material is rated UL 94V-0.

11. The battery pack of claim 1, wherein a density of the encapsulating foam material is between 3-8 lbs/ft³.

12. The battery pack of claim 1, wherein a compressive yield strength of the encapsulating foam material is between 15-30 MPa.

13. A method of producing a battery pack comprising:
providing a battery pack housing;
providing a first material configured to expand into an encapsulating foam material;
providing a first plurality of cells comprising a first plurality of corresponding cell vents;
arranging the first plurality of cells in the battery pack housing, each cell of the first plurality of cells including a cell vent arranged on a first side of the cell;
providing a vent channel comprising: a first reception duct that comprises a plurality of adjacent sections, and a connection duct;
positioning the vent channel in place in the battery pack, by introducing the first material to the battery pack, and hardening the first material to generate the encapsulating foam material, such that the first reception channel is disposed opposite the first plurality of corresponding cell vents and such that each corresponding cell vent corresponds to and faces an adjacent section of the plurality of adjacent sections;
wherein a melting point of the material of the plurality of adjacent sections is below a predetermined cell venting temperature, and
wherein each adjacent section melts upon contact with escaping gas from the corresponding cell vent to direct the escaping gas to an external area of the battery pack through the connection duct.

14. The method of claim 13, wherein the melting point of the material of the plurality of adjacent sections is below the melting point of the material of a remainder of the vent channel.

15. The method of claim 13, wherein the melting point of the encapsulating foam material is below the predetermined cell venting temperature.

16. The method of claim 13, wherein the first material is a liquid.

17. The method of claim 13, wherein the vent channel is further positioned in place with a fixture prior to introducing the first material.

18. The method of claim 17, wherein the fixture is removed after expansion of the first material.

19. The method of claim 13, further comprising:
disposing the first plurality of cells in a module of the battery pack.

20. The method of claim 13, further comprising:
providing at least one other plurality of cells and one at least one other reception duct corresponding to the at least one other plurality of cells, and
configuring the at least one other reception duct with another plurality of adjacent sections to direct the escaping gas from the at least one other plurality of cells to the external area of the battery pack through the connection duct.
